(19) United States
(12) Patent Application Publication
(10) Pub. No.: US 2016/0276736 A1
(43) Pub. Date: Sep. 22, 2016

(54) External Antenna

(71) Applicant: ZTE CORPORATION, Shenzhen, Guangdong (CN)

(72) Inventors: Lanying Qu, Shenzhen (CN); Yangfeng Ma, Shenzhen (CN)

(21) Appl. No.: 15/032,591

(22) PCT Filed: Apr. 21, 2014
(86) PCT No.: PCT/CN2014/075826

§ 371 Date: Apr. 27, 2016

(30) Foreign Application Priority Data
Oct. 30, 2013 (CN) 201320682636.X

(51) Int. Cl. H01Q 1/24; H01Q 1/50; H01R 24/64; H01Q 1/27

(52) U.S. Cl. CPC H01Q 1/242; H01Q 1/273; H01Q 1/50; H01R 24/64; H01R 2107/00

(57) ABSTRACT

An external antenna is described in the present disclosure, and the external antenna includes an antenna body and a matching circuit, wherein the antenna body and the matching circuit are connected through an idle pin of a Universal Serial Bus (USB) interface.

### TECHNICAL FIELD

The present disclosure relates to an antenna technology for a wireless terminal, and more particularly, to an external antenna.

### BACKGROUND

Along with the increasing development of a wireless technology, a wireless terminal more and more tends to be designed to be miniature and ultrathin, while a certain spatial length is required by external signal radiation of an antenna of the wireless terminal, so that some miniature terminals has poorer antenna performance under limits of an antenna size and position.

### SUMMARY

A main purpose of an embodiment of the present disclosure is to provide an external antenna, which can reduce a space occupied by an antenna in terminal equipment and solve the problem of poor antenna performance of miniature terminal equipment.

The technical solution of the embodiment of the present disclosure is implemented as follows.

The embodiment of the present disclosure provides an external antenna, which includes an antenna body and a matching circuit, wherein

the antenna body and the matching circuit are connected through an idle pin of a Universal Serial Bus (USB) interface.

Preferably, the external antenna may further include: an antistatic inductance coil or magnetic bead; and the antistatic inductance coil or magnetic bead may be arranged between the matching circuit and the idle pin of the USB interface, or may be arranged before a radio frequency test port.

Preferably, the external antenna may further include: an antenna fixing buckle which fixes the antenna body to terminal equipment.

Preferably, the USB interface may be a Micro-USB interface, or a Mini-USB interface.

Preferably, the idle pin may be an Identity (ID) pin of the USB interface.

Preferably, the antenna body may be integrated in a strap of the terminal equipment, or the antenna body may exist independently.

The external antenna provided by the embodiment of the present disclosure includes the antenna body and the matching circuit; the antenna body and the matching circuit are connected through the idle pin of the USB interface; the antenna body is arranged outside the terminal equipment, so that a space occupied by the antenna in the terminal equipment is reduced, and the terminal equipment may be conveniently designed to be miniature and ultrathin; and in addition, the external antenna is usually higher in signal receiving performance, so that the problem of poor antenna performance of a miniature terminal is also solved. Moreover, the USB interface is adopted for connection, so that convenience and flexibility in plugging and unplugging and more convenience for use of a user are ensured.

### BRIEF DESCRIPTION OF THE DRAWINGS

FIG. 1 is a structure diagram of an external antenna according to an embodiment of the present disclosure;

FIG. 2a and FIG. 2b are structure diagrams of two embodiments of an external antenna according to the present disclosure;

FIG. 3 is a structural effect diagram of implementation of an external antenna on a terminal according to an embodiment of the present disclosure; and

FIG. 4 is another structural effect diagram of implementation of an external antenna on a terminal according to an embodiment of the present disclosure.

### DETAILED DESCRIPTION

In embodiments of the present disclosure, an antenna body and a matching circuit are connected through an idle pin of a USB interface, so that a radio frequency signal passes through the matching circuit and the USB interface after being transmitted from a radio frequency circuit, and finally reaches the antenna body.

The present disclosure will be further described below with reference to the accompanying drawings and specific embodiments in detail.

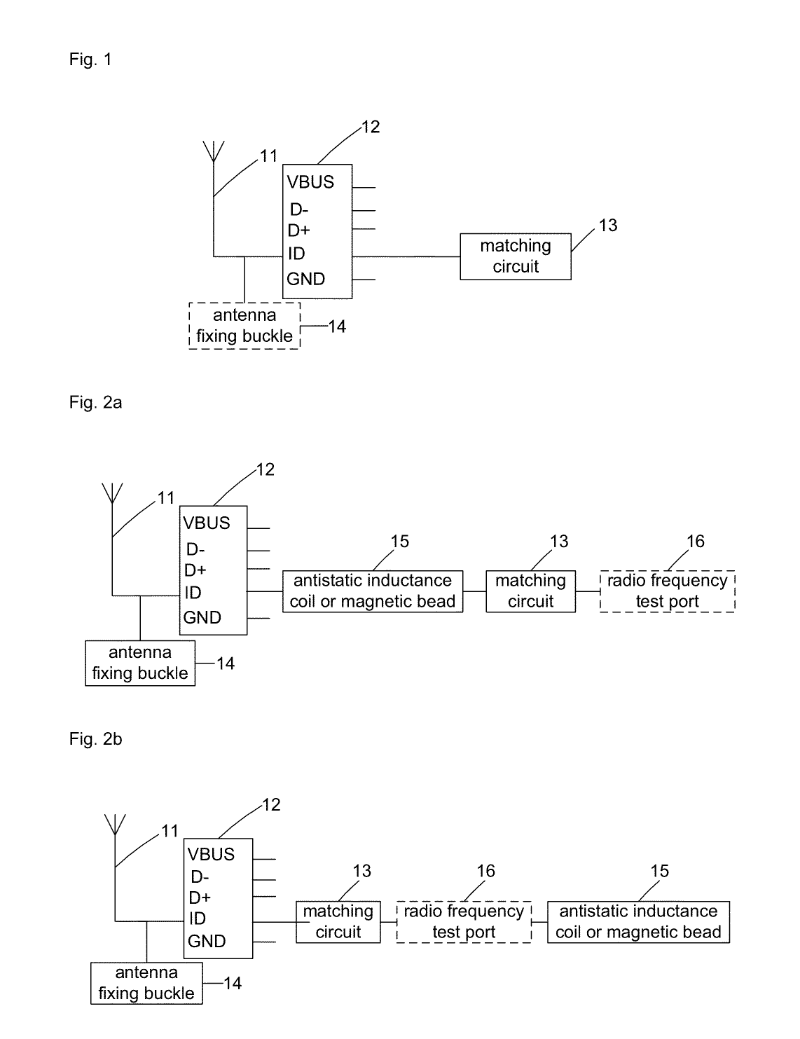

FIG. 1 is a structure diagram of an external antenna according to an embodiment of the present disclosure, as shown in FIG. 1, the external antenna includes: an antenna body 11, a USB interface 12 and a matching circuit 13; and the antenna body 11 and the matching circuit 13 are connected through an idle pin of the USB interface 12.

Here, the antenna body may be a main antenna, a diversity antenna, or a Global Positioning System (GPS) antenna, or a Wireless-Fidelity (Wi-Fi) antenna, or a Bluetooth antenna; and

the USB interface 12 may be a Micro-USB interface, or a Mini-USB interface, wherein the Micro-USB interface and the Mini-USB interface are portable versions of a USB 2.0 interface standard respectively, and follow the USB 2.0 interface standard.

Correspondingly, the idle pin is an ID pin of the USB interface 12, and may specifically be an ID pin of the Micro-USB interface, or an ID pin of the Mini-USB interface.

During a practical application, the antenna body 11 may be integrated in a strap of terminal equipment, and may also exist independently in form of fitting; and the antenna body 11 may adopt a monopole form, and may also be grounded through a ground pin of the USB interface or a peripheral metal of the USB interface.

The matching circuit 13 consists of inductance, resistance and capacitance devices, and a form of the matching circuit 13 is an L type, a dual-L type, or a II type, and may specifically be determined according to a frequency band and practical debugging.

Preferably, the matching circuit 13 may be connected with a radio frequency test port capable of providing an adaptation interface for a radio frequency signal, so that the radio frequency signal transmitted by a radio frequency circuit reaches the matching circuit 13 through the radio frequency test port, and then reaches the antenna body 11 through the matching circuit 13 and the idle pin of the USB interface 12.

Preferably, the external antenna further includes: an antenna fixing buckle 14, configured to fix the antenna body 11 to the terminal equipment.

In another preferred embodiment, the external antenna further includes: an antistatic inductance coil or magnetic bead, configured for antistatic interference. FIG. 2a and FIG. 2b are structure diagrams of two embodiments of an external antenna according to the present disclosure; based on the external antenna shown in FIG. 1, the antistatic inductance coil or magnetic bead 15 may be arranged between the matching circuit 13 and the idle pin of the USB interface 12, as shown in FIG. 2a, and may also be arranged before the radio frequency test port 16, one end of the radio frequency test port 16 being connected with the matching circuit 13 while the other end being connected with the antistatic inductance coil or magnetic bead 15, as shown in FIG. 2b.

During a practical application, the antistatic inductance coil or magnetic bead 15 may be replaced with another antistatic manner; during debugging of the antenna and the matching circuit, an antenna matching circuit may also be adopted to prevent static electricity.

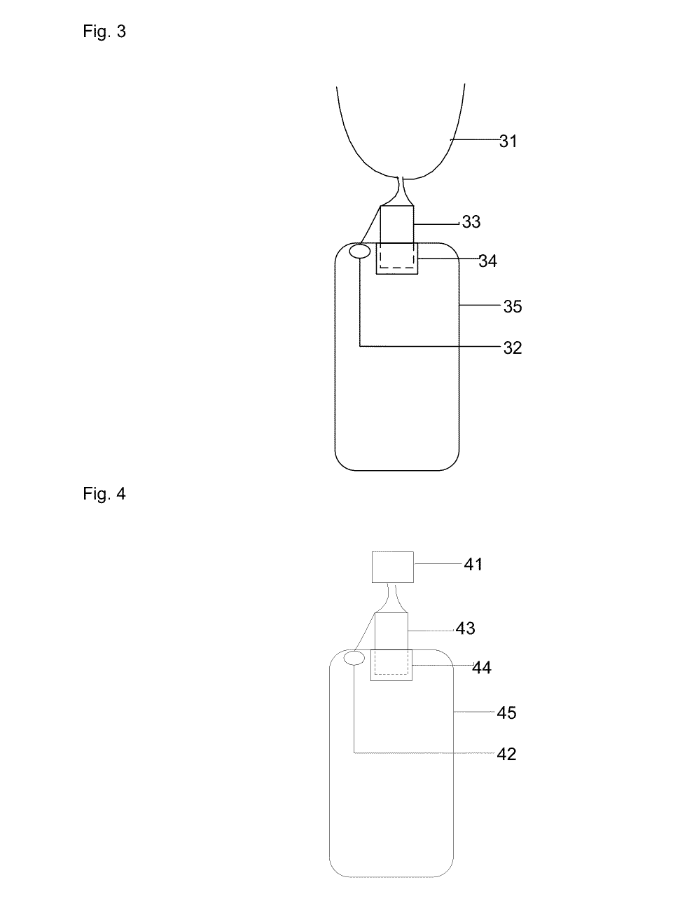

FIG. 3 is a structural effect diagram of implementation of an external antenna on a terminal according to an embodiment of the present disclosure. In this embodiment, a USB interface adopts a Micro-USB interface, as shown in FIG. 3, the external antenna includes: an antenna body 31, an antenna fixing buckle 32, a Micro-USB interface end A 33, a Micro-USB interface end B 34 and a matching circuit located in terminal equipment 35, wherein

the antenna body 31 is connected with the terminal equipment 35 through idle pins of the Micro-USB interface end A 33 and the Micro-USB interface end B 34, wherein the Micro-USB interface end A 33 and the Micro-USB interface end B 34 form the Micro-USB interface; the Micro-USB interface end A 33 is equivalent to a plug side;

the Micro-USB interface end B 34 is equivalent to a socket side; and correspondingly, the idle pins are ID pins of the Micro-USB interface.

Here, the antenna body 31 may be a main antenna, or a GPS antenna, or a Wi-Fi antenna, or the like;

the Micro-USB interface is a portable version of a USB 2.0 interface standard, and follows the USB 2.0 interface standard; and

the matching circuit consists of inductance, resistance and capacitance devices, and a form of the matching circuit 13 is an L type, a dual-L type, or a II type, and may specifically be determined according to a frequency band and practical debugging.

Preferably, the matching circuit may be connected with a radio frequency test port capable of providing an adaptation interface for a radio frequency signal, so that the radio frequency signal transmitted by a radio frequency circuit reaches the matching circuit through the radio frequency test port, and then reaches the antenna body through the matching circuit and the ID pins of the Micro-USB interface end A 33 and the Micro-USB interface end B 34; and

preferably, the external antenna in this embodiment may further include an antistatic inductance coil or magnetic bead, configured for antistatic interference; and the antistatic inductance coil or magnetic bead may be arranged between the matching circuit and the ID pin of the Micro-USB interface end B 34, as shown in FIG. 2a, and may also be arranged before the radio frequency test port, as shown in FIG. 2b.

During a practical application, the antistatic inductance coil or magnetic bead may also be replaced with another antistatic manner; during debugging of the antenna and the matching circuit, an antenna matching circuit may also be adopted to prevent static electricity.

In this embodiment, the antenna body 31 is integrated in a strap of the terminal equipment 35; the antenna fixing buckle 32 is configured to fix the antenna body 31 to the terminal equipment 35; and

preferably, the antenna body 31 may adopt a monopole form, and may also be grounded through ground pins of the Micro-USB interface end A 33 and the Micro-USB interface end B 34, or through peripheral metals of the Micro-USB interface end A 33 and the Micro-USB interface end B 34.

FIG. 4 is another structural effect diagram of implementation of an external antenna on a terminal according to an embodiment of the present disclosure, in this embodiment, a USB interface adopts a Mini-USB interface. As shown in FIG. 4, the external antenna includes: an antenna body 41, an antenna fixing buckle 42, a Mini-USB interface end A 43, a Mini-USB interface end B 44 and a matching circuit located in terminal equipment 45, wherein

the antenna body 41 is connected with the terminal equipment 45 through idle pins of the Mini-USB interface end A 43 and the Mini-USB interface end B 44, wherein the Mini-USB interface end A 43 and the Mini-USB interface end B 44 form the Mini-USB interface; the Mini-USB interface end A 43 is equivalent to a plug side; the Mini-USB interface end B 44 is equivalent to a socket side; and correspondingly, the idle pins are ID pins of the Mini-USB interface.

Here, the antenna body 41 may be a main antenna, or a GPS antenna, or a Wi-Fi antenna, or the like;

the Mini-USB interface is a portable version of a USB 2.0 interface standard, and follows the USB 2.0 interface standard; and

the matching circuit consists of inductance, resistance and capacitance devices, and a form of the matching circuit 13 is an L type, a dual-L type, or a II type, and may specifically be determined according to a frequency band and practical debugging.

Preferably, the matching circuit may be connected with a radio frequency test port capable of providing an adaptation interface for a radio frequency signal, so that the radio frequency signal transmitted by a radio frequency circuit reaches the matching circuit through the radio frequency test port, and then reaches the antenna body 41 through the matching circuit and the ID pins of the Micro-USB interface end A 43 and the Micro-USB interface end B 44; and

preferably, the external antenna in this embodiment may further include an antistatic inductance coil or magnetic bead, configured for antistatic interference; the antistatic inductance coil or magnetic bead may be arranged between the matching circuit and the ID pin of the Micro-USB interface end B 44, as shown in FIG. 2a, and may also be arranged before the radio frequency test port, as shown in FIG. 2b.

During a practical application, the antistatic inductance coil or magnetic bead may also be replaced with another antistatic manner; during debugging of the antenna and the matching circuit, an antenna matching circuit may also be adopted to prevent static electricity.

In this embodiment, the antenna body 41 is an independent fitting;

the idle pins are ID pins; the antenna fixing buckle 42 is configured to fix the antenna body 41 to the terminal equipment 45; and

preferably, the antenna body 41 may adopt a monopole form, and may also be grounded through ground pins of the Mini-USB interface end A 43 and the Mini-USB interface end B 44 or peripheral metals of the Mini-USB interface end A 43 and the Mini-USB interface end B 44.

The above is only preferred embodiment of the present disclosure and not intended to limit the scope of protection of the present disclosure.

### INDUSTRIAL APPLICABILITY

According to an embodiment of the present disclosure, an antenna body is arranged outside terminal equipment through a USB interface, so that a space occupied by an antenna in the terminal equipment is reduced, and the terminal equipment may be conveniently designed to be miniature and ultrathin; in addition, the external antenna is usually higher in signal receiving performance, so that the problem of poor antenna performance of a miniature terminal is also solved. Moreover, the USB interface is adopted for connection, so that convenience and flexibility in plugging and unplugging and more convenience for use of a user are ensured.

What is claimed is:

1. An external antenna, comprising an antenna body and a matching circuit, wherein,
the antenna body and the matching circuit are connected through an idle pin of a Universal Serial Bus (USB) interface.

2. The external antenna according to claim 1, further comprising: an antistatic inductance coil or magnetic bead, wherein the antistatic inductance coil or magnetic bead is arranged between the matching circuit and the idle pin of the USB interface, or is arranged before a radio frequency test port.

3. The external antenna according to claim 1, further comprising: an antenna fixing buckle which fixes the antenna body to terminal equipment.

4. The external antenna according to claim 1, wherein the USB interface is a Micro-USB interface, or a Mini-USB interface.

5. The external antenna according to claim 4, wherein the idle pin is an Identity (ID) pin of the USB interface.

6. The external antenna according to claim 1, wherein the antenna body is integrated in a strap of the terminal equipment, or the antenna body exists independently.

7. The external antenna according to claim 2, wherein the USB interface is a Micro-USB interface, or a Mini-USB interface.

8. The external antenna according to claim 3, wherein the USB interface is a Micro-USB interface, or a Mini-USB interface.

9. The external antenna according to claim 7, wherein the idle pin is an Identity (ID) pin of the USB interface.

10. The external antenna according to claim 8, wherein the idle pin is an Identity (ID) pin of the USB interface.

11. The external antenna according to claim 2, wherein the antenna body is integrated in a strap of the terminal equipment, or the antenna body exists independently.

12. The external antenna according to claim 3, wherein the antenna body is integrated in a strap of the terminal equipment, or the antenna body exists independently.
